(19) United States
(12) Patent Application Publication
(10) Pub. No.: US 2006/0076012 A1
(43) Pub. Date: Apr. 13, 2006

(54) Powered respirator

(76) Inventors: Naoto Tanizawa, Tokyo (JP); Hiroyuki Ide, Saitama-shi (JP); Hidetoshi Nagasawa, Saitama-shi (JP)

Correspondence Address: FLYNN THIEL BOUTELL & TANIS, P.C., 2026 RAMBLING ROAD, KALAMAZOO, MI, 49008-1631, US

(21) Appl. No.: 11/246,624

(22) Filed: Oct. 6, 2005

(30) Foreign Application Priority Data
Oct. 7, 2004 (JP) 2004-295357

(51) Int. Cl. A62B 7/10; A62B 23/02; A62B 19/00

(52) U.S. Cl. 128/201.25; 128/206.17; 128/206.16

(57) ABSTRACT

A powered respiration comprising, an air supplying unit and a filter equipped to a face piece part of said powered respiration, wherein an electric fan, a motor and a battery are installed in said air supplying unit.

### FIELD OF THE INVENTION

The present invention relates to a powered respirator with an electric fan which can be used as a dust proof mask or a gas mask at a place where dust or poisonous gas are generated such as factory, construction field or tunnel construction field.

### BACKGROUND OF THE INVENTION

In general, said kind of powered respirator with an electric fan is comprising of a face piece part that covers at least nose and mouth of a user, an electric fan, a motor which drives the electric fan and a filter and has a structural feature characterizing that clean air from which fine particles drifting in atmosphere are removed by means of the electric fan and the filter to a face of the user. For the above purpose, an air line hose to supply clean air or an electric source cable to transmit electricity to the motor are equipped to the conventional powered respirator, therefore a user who wear the conventional powered respirator feels inconveniences while at work. In particular, in a case of tunnel construction field, a powered respirator equipped with an electric source cable can not be used in a working face where an explosive such as dynamite is used from the safety view point, therefore, a powered respirator without an electric source cable is needed in a working face.

To improve above mentioned problem, various kinds of respirator are proposed, for example, in Patent Document 1, a respirator with an electric fan unit to which a filter and an electric fan are equipped is disclosed. However, this respirator is necessary to provide electric source cables to transmit electricity to electric fun units locating right and left positions from a battery. Further, in Patent Document 2, a powered respirator characterizing, containing a fan unit installing an electric fan in a main body of casing, a filter is equipped to the main body of casing at up stream side to a suction opening of the fan unit, existing a cylindrical duct between the suction opening of the fan unit and the filter in the main body of casing, and press adhering one end of duct with the suction opening of the fan unit and another end of duct with the filter is disclosed.

Patent Document 1: JP Laid open publication 2003-117013

Patent Document 2: JP Laid open publication 2004-16466

### OBJECT OF THE INVENTION

The inventors of the present invention have earnestly investigated about a respirator of simple structure, easy wearing for a user and promises easy working for the user even if the user is wearing the respirator, and accomplished the present invention. That is, the object of the present invention is to provide a respirator of simple structure and easy wearing.

### DISCLOSURE OF THE INVENTION

The important point of the present invention is a respirator comprising an air supplying unit and a filter at a face piece part, wherein an electric fan, a motor and a battery are built in to said air supplying unit.

Effect of the Invention

Since the respirator of the present invention is characterized that an electric fan, a motor and a battery are built in by forming one body in an air supplying unit, it has advantageous that it is not necessary to equip an electric source cable or an air supplying tube which are necessary parts of a conventional powered respirator, further, structure is simple and easy wearing for a user, and promises easy working for the user even if the used is wearing the respirator,

### BRIEF ILLUSTRATION OF DRAWINGS

FIG. 1: Perspective view showing the state that the powered respirator of the present invention is worn together with a helmet.

FIG. 2: Perspective view showing that the powered respirator of the present invention is exploded to each part.

FIG. 3: Cross sectional view of the powered respirator of the present invention.

### ILLUSTRATION OF MARKS

1: face piece part 2: air supplying unit 3: filter 4: voice tube 5: fastening string 6: helmet 7: face piece side part of air supplying unit 8: battery holding side part of air supplying unit 9: battery 10: power supply switch 11: inhalation valve 12: exhaust valve 13: motor 14: electric fan 15: battery cover

### DETAIL DESCRIPTION OF THE INVENTION

The present invention will be illustrated in more detail.

The face piece part of the present invention can be a whole surface face piece part covering whole face of a user, or can be a half surface face piece part covering nose and mouth of a user, and a part which contacts with the face, forms a dual structure composed of an elastic material such as silicone rubber or nitrile rubber. At the surface side of the powered respirator of the present invention, a filter, an air release valve and a fastening string are equipped, and these structural features are similar to a conventional powered respirator. The important point of the present invention is that the powered respirator of the present invention is further equipped an air supplying unit. The reverse surface side of the powered respirator of the present invention, forms a face contacting part characterizing to wrap a face, and a material can be same as to that of the surface side. And when constructed by a slightly thinner material than that of the surface side, wearing stability is improved and is desirable. The air releasing valve can be same as to the air releasing valve used in the conventional powered respirator, and releases excess clean air supplied from the air supplying unit and expiration.

Further, it is desirable to provide a voice tube to the face piece part which makes possible to converse with a parson of outside. Further, supposing the together use with a helmet, it is desirable to equip a fastening string, and a structure to support a wide width fastening string by a brim of helmet promises further improvement of wearing stability.

To the air supplying unit, an electric fan, a motor and a battery are built in by forming one body, and the surface of battery is covered by a battery cover composed of hard synthetic resin so as to protect falling down of the battery. And a power supply switch, which also acts as an air flow adjusting knob, is equipped. By turning the switch, the electric fan is actuated, and by further turning the switch the volume of air flow is adjusted. Still further, it is desirable to equip a remaining capacity indicating lamp of battery and to indicate electric charge state of a battery.

### EXAMPLE

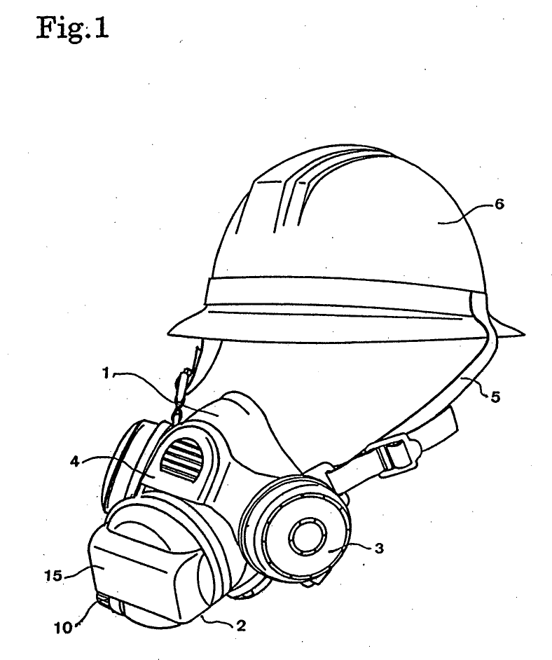

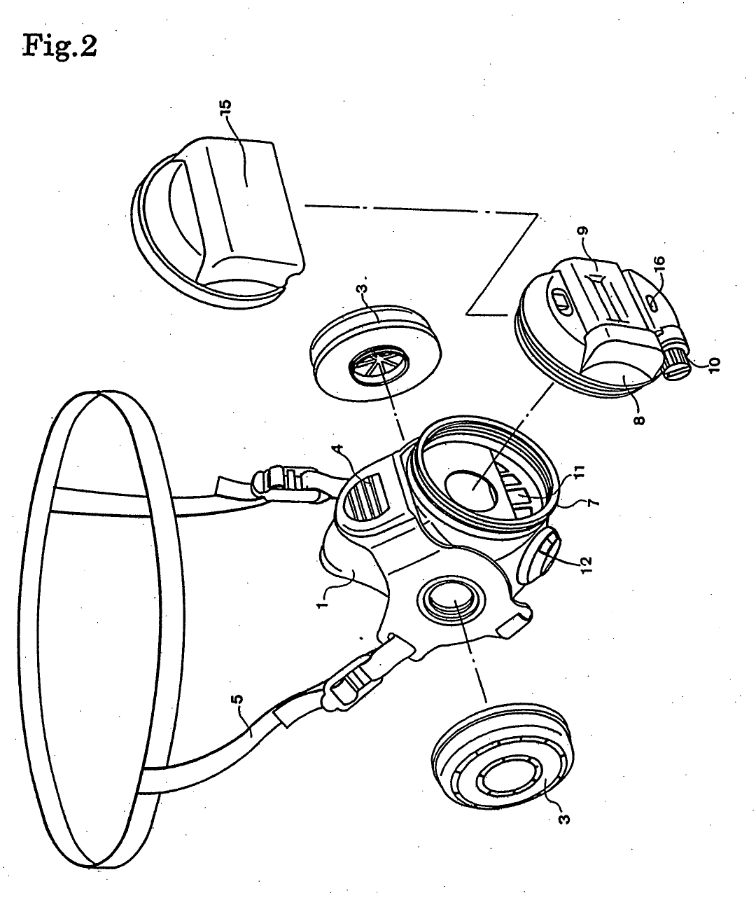

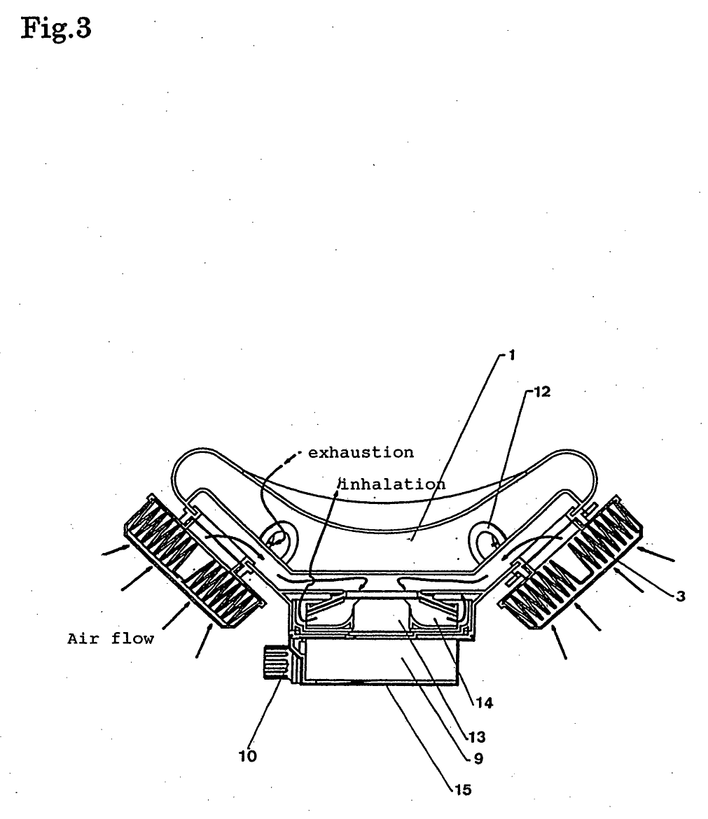

The Example present invention will be illustrated more in detail according to drawings, however, not intending to limit the scope of the present invention. FIG. 1 is a perspective view showing the state that the powered respirator of the present invention is wear together with a helmet, and FIG. 2 is a perspective view showing that the powered respirator of the present invention is exploded to each part. In FIG. 1, in the center of a face piece part 1, which covers nose and mouth, a air supplying unit 2 comprising a battery 9 and a fan motor is equipped and a filter 3 is provided at the right and left parts. And on the upper part of the air supplying unit 2, which locates at the center part, a voice tube 4 is equipped so as to make the conversation with a parson of outside possible. At the both sides of the face piece part 1, a fastening string 5 is provided so as to support by a brim of helmet 6 which the user wears, thus the powered respiration of the present invention can be wear: FIG. 2 shows that in the air supplying unit 2, a part 7 which is installed to a face piece part 1 and a part 8 to hold a battery is fixed by a screw socket. At the center of the part 8 to install a battery, the battery 9 is installed and at down stream side, a power supply switch 10, which also acts as an air flow adjusting knob is equipped. And a motor and an electric fan are installed in inside of it. This part is shown in FIG. 3 which is the cross sectional view of the powered respiration of the present invention. In FIG. 3, at upper part and lower part of inside of the a part 7 which is installed to the air supplying unit 2 of the face piece part, an inhalation valve 11 which connects to the filter 3 equipped to the face piece part 1 is equipped, and an exhaust valve 12 which is opened from inside of the face piece part to outside is equipped. 15 shows a battery cover.

The air flow of the powered respiration of the present invention when the power supply switch 10 is on is indicated by arrow marks in FIG. 3. That is, the electric fan rotates and draws outside air, and the drawn outside air is cleaned by passing through a filter, then introduced into the face piece part by the inhalation valve 11. Therefore, the user can be always in the atmosphere of clean air. And expiration of the user and excess clean air are released from the exhaust valve 12 equipped to the outside of the face piece part.

### INDUSTRIAL APPLICABILITY

Since the powered respiration of the present invention does not have an electric source cable or an air line hose, the powered respiration of the present invention is suited to be used as a dust proof mask or a gas mask at the place where dust or poisonous gas are generated such as factory or construction field.

What is claim:

1. A powered respiration comprising, an air supplying unit and a filter equipped to a face piece part of said powered respiration, wherein an electric fan, a motor and a battery are installed in said air supplying unit.

2. The powered respiration of claim 1, wherein a voice tube is installed in the face piece part.
